(19) United States
(12) Patent Application Publication
(10) Pub. No.: US 2014/0123623 A1
(43) Pub. Date: May 8, 2014

(54) GAS TURBOMACHINE SYSTEM INCLUDING AN INLET CHILLER CONDENSATE RECOVERY SYSTEM

(71) Applicant: GENERAL ELECTRIC COMPANY, Schenectady, NY (US)

(72) Inventors: Joseph John, Bangalore (IN); Indrajit Mazumder, Bangalore (IN); Bhaskar Pemmi, Bangalore (IN)

(73) Assignee: GENERAL ELECTRIC COMPANY, Schenectady, NY (US)

(21) Appl. No.: 13/672,332

(22) Filed: Nov. 8, 2012

(51) Int. Cl. F02C 7/143; F01K 23/10

(52) U.S. Cl. CPC F02C 7/143; F01K 23/10
USPC 60/39.182; 60/806

(57) ABSTRACT

A gas turbomachine system includes a compressor portion including an inlet portion, a turbine portion fluidically connected to, and mechanically linked with, the compressor portion, and a combustor assembly including at least one combustor fluidically connected to the turbine portion. An inlet system is fluidically connected to the inlet portion of the compressor portion. The inlet system includes an inlet chiller. An inlet chiller condensate recovery system is fluidically connected to the inlet system. The inlet chiller condensate recovery system includes an inlet fluidically connected to the inlet chiller and an outlet fluidically connected to one of the compressor portion and the combustor assembly.

### BACKGROUND OF THE INVENTION

The subject matter disclosed herein relates to turbomachines and, more particularly, to a gas turbomachine system including an inlet chiller condensate recovery system.

Gas turbomachines include a compressor portion linked to a turbine portion through a common compressor/turbine shaft and a combustor assembly. An inlet airflow is passed through an air intake toward the compressor portion. In the compressor portion, the inlet airflow is compressed through a number of sequential stages toward the combustor assembly. In the combustor assembly, the compressed airflow mixes with a fuel to form a combustible mixture. The combustible mixture is combusted in the combustor assembly to form hot gases. The hot gases are guided to the turbine portion through a transition piece. The hot gases expand through the turbine portion acting upon turbine blades mounted on wheels to create work that is output, for example, to power a generator, a pump, or to provide power to a vehicle.

In some cases, the inlet airflow is cooled prior to entering the compressor portion. When cooling is desired, an inlet chiller is arranged in the air intake. Cooling increases a mass flow rate of the inlet air leading to various efficiencies in the gas turbomachine. Cooling the inlet airflow may also introduce moisture into the inlet air. Unregulated introduction of moisture into the gas turbomachine may cause damage to various internal components of the compressor portion and/or the turbine portion. Accordingly, it generally desirable to remove the moisture from the inlet airflow. Thus, many air intakes include mist eliminators arranged downstream of the inlet chiller to remove and collect moisture from the inlet airflow.

### BRIEF DESCRIPTION OF THE INVENTION

According to one aspect of an exemplary embodiment, a gas turbomachine system includes a compressor portion including an inlet portion, a turbine portion fluidically connected to and mechanically linked with the compressor portion, and a combustor assembly including at least one combustor fluidically connected to the turbine portion. An inlet system is fluidically connected to the inlet portion of the compressor portion. The inlet system includes an inlet chiller. An inlet chiller condensate recovery system is fluidically connected to the inlet system and one of the compressor portion and the combustor assembly.

According to another aspect of an exemplary embodiment, a combined cycle power plant (CCPP) includes a gas turbomachine system including a compressor portion having an inlet portion, a turbine portion fluidically connected to, and mechanically linked with, the compressor portion, and a combustor assembly, including at least one combustor, fluidically connected to the turbine portion. An inlet system is fluidically connected to the inlet portion of the compressor portion. The inlet system includes an inlet chiller. The combined cycle power plant also includes a steam turbine portion, and a heat recovery steam generator (HRSG) fluidically connected to the steam turbine portion. An inlet chiller condensate recovery system is fluidically connected to the inlet system. The inlet chiller condensate recovery system is fluidically connected to the inlet chiller and the HRSG.

According to yet another aspect of an exemplary embodiment, a combined cycle power plant (CCPP) includes a gas turbomachine system including a compressor portion having an inlet portion, a turbine portion fluidically connected to, and mechanically linked with, the compressor portion, and a combustor assembly including at least one combustor fluidically connected to the turbine portion. An inlet system is fluidically connected to the inlet portion of the compressor portion, the inlet system including an inlet chiller. The combined cycle power plant also includes a steam turbine portion, and a heat recovery steam generator (HRSG) fluidically connected to the steam turbine portion. An inlet chiller condensate recovery system is fluidically connected to the inlet system. The inlet chiller condensate recovery system is fluidically connected to the inlet chiller and to one of the compressor portion, the combustor assembly, and the HRSG.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a gas turbomachine system including an inlet chiller condensate recovery system in accordance with an exemplary embodiment;

FIG. 2 is a schematic view of a gas turbomachine system including an inlet chiller condensate recovery system in accordance with another aspect of the exemplary embodiment;

FIG. 3 is a schematic view of a gas turbomachine system including an inlet chiller condensate recovery system in accordance with another aspect of the exemplary embodiment; and

FIG. 4 is a schematic view of a combined cycle power plant including an inlet chiller condensate recovery system in accordance with an exemplary embodiment;

The detailed description explains embodiments of the invention, together with advantages and features, by way of example with reference to the drawings.

### DETAILED DESCRIPTION OF THE INVENTION

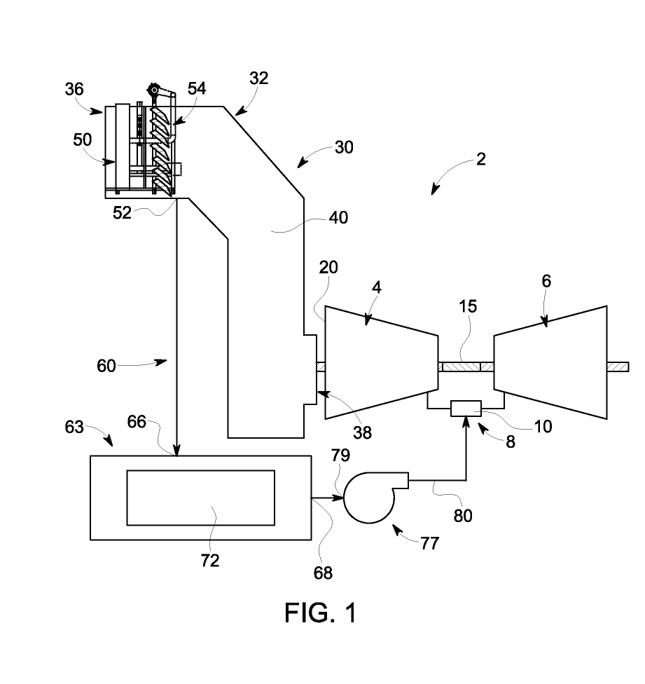

A gas turbomachine system in accordance with an exemplary embodiment is indicated generally at 2 in FIG. 1. Gas turbomachine system 2 includes a compressor portion 4 that is fluidically connected to a turbine portion 6 through a combustor assembly 8. Combustor assembly 8 includes one or more combustors 10. Combustors 10 may be arranged in a variety of geometries including, for example, a can-annular array. Compressor portion 4 is also mechanically linked to turbine portion 6 through a common compressor/turbine shaft 15. Compressor portion 4 includes an inlet portion 20 that receives air through an inlet system 30. Inlet system 30 includes a duct member 32 having an inlet section 36 that extends to an outlet section 38 through an intermediate or duct portion 40. Inlet system 30 also includes an inlet chiller 50 having a condensate outlet 52 that passes condensate collecting at inlet section 36 from inlet system 30. In addition, a mist eliminator 54 is positioned downstream from inlet chiller 50 to limit moisture from passing through inlet system 30 into inlet portion 20 of compressor portion 4. Inlet chiller 50 lowers a temperature of air entering inlet section 36. Lowering a temperature of incoming air increases an overall mass flow rate of air through compressor portion 4.

In accordance with an exemplary embodiment, gas turbomachine system 2 includes an inlet chiller condensate recovery system 60. Inlet chiller condensate recovery system 60 captures condensate passing from inlet system 30 for re-use in gas turbomachine system 2. Re-use or reclaiming inlet chiller condensation is particularly advantageous in arid climates in which water is scarce. However, inlet chiller condensate recovery system 60 may be employed in a variety of climates and should not be considered to be limited for use in arid or dry climates.

Inlet chiller condensate recovery system 60 includes a storage tank 63 that receives and stores inlet chiller condensate from inlet chiller 50. Storage tank 63 includes an inlet 66 fluidically connected to condensate outlet 52 and an outlet 68. In accordance with an aspect of the exemplary embodiment, storage tank 63 is provided with a de-ionizer 72 that conditions the inlet chiller condensate to meet conductivity requirements for use in combustor 10. Inlet chiller condensate recovery system 60 also includes a pump 77 that guides inlet chiller condensate from storage tank 63. Pump 77 includes an inlet portion 79 fluidically connected to outlet 68 of storage tank 63 and an outlet portion 80 that is fluidically connected to combustor 10. In accordance with the exemplary embodiment shown, pump 77 delivers inlet chiller condensate as an injection medium associated with the use of liquid fuels. The introduction of inlet chiller condensate into combustor 10 contributes to NOx abatement in gas turbomachine emissions.

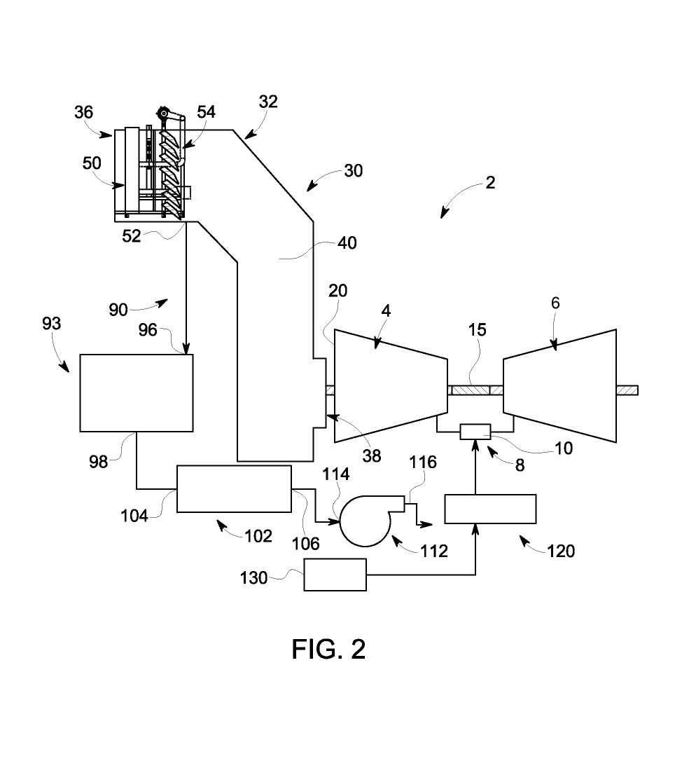

Reference will now be made to FIG. 2, wherein like reference numbers represent corresponding parts in the respective views, in describing an inlet chiller condensate recovery system 90 in accordance with another aspect of an exemplary embodiment. Inlet chiller condensate recovery system 90 includes a storage tank 93 having an inlet 96 fluidically connected to condensate outlet 52 and an outlet 98. A de-ionizing tank 102 is fluidically connected to storage tank 93. Specifically, de-ionizing tank 102 includes an inlet section 104 fluidically connected to outlet 98 and an outlet section 106. Inlet chiller condensate recovery system 90 also includes a pump 112. Pump 112 includes an inlet portion 114 fluidically connected to outlet section 106. Pump 112 includes an outlet portion 116 fluidically connected to an atomizer 120. Atomizer 120 delivers an atomized fluid to combustor 10. In accordance with an aspect of the exemplary embodiment, atomizer 120 delivers an atomized mixture or emulsification of a liquid fuel from a liquid fuel source 130 and inlet chiller condensate from inlet chiller 50 to combustor 10. As discussed above, the introduction of inlet chiller condensate into combustor 10 contributes to NOx abatement in gas turbomachine emissions.

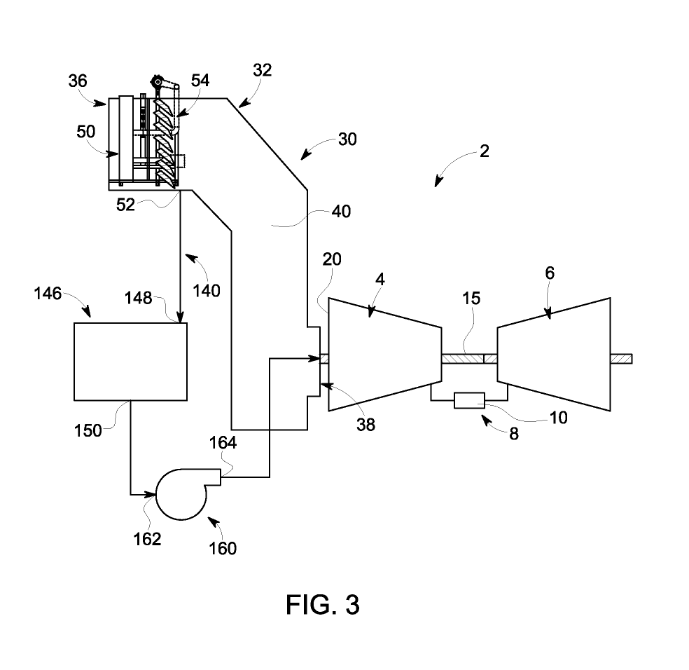

Reference will now be made to FIG. 3, wherein like reference numbers represent corresponding parts in the respective views, in describing an inlet chiller condensate recovery system 140 in accordance with another aspect of an exemplary embodiment. Inlet chiller condensate recovery system 140 includes a storage tank 146 having an inlet 148 fluidically connected to condensate outlet 52 and an outlet 150. Inlet chiller condensate recovery system 140 also includes a pump 160. Pump 160 includes an inlet portion 162 fluidically connected to outlet 150 of storage tank 146 and an outlet portion 164 fluidically connected to inlet portion 20 of compressor portion 4. With this arrangement, inlet chiller condensate is introduced into inlet portion 20 to facilitate both an online and/or an offline water wash of compressor portion 4.

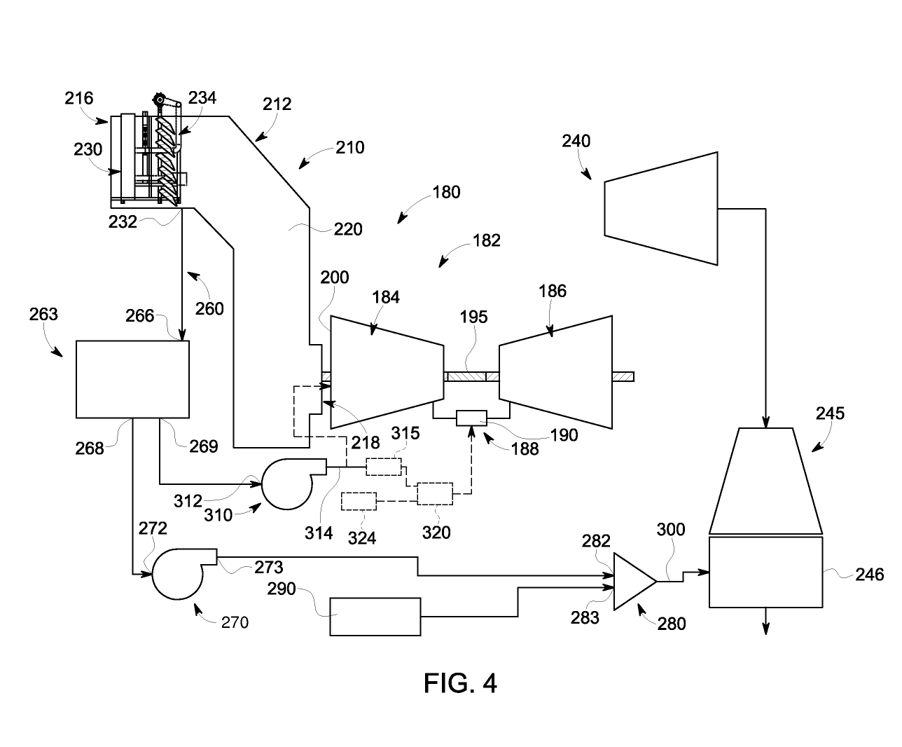

Reference will now be made to FIG. 4 in describing a combined cycle power plant (CCPP) 180 in accordance with another aspect of the exemplary embodiment. CCPP 180 includes a gas turbomachine system 182 including a compressor portion 184 that is fluidically connected to a turbine portion 186 through a combustor assembly 188. Combustor assembly 188 includes one or more combustors 190. Combustors 190 may be arranged in a variety of geometries including, for example, a can-annular array. Compressor portion 184 is also mechanically linked to turbine portion 186 through a common compressor/turbine shaft 195. Compressor portion 184 includes an inlet portion 200 that receives air through an inlet system 210. Inlet system 210 includes a duct member 212 having an inlet section 216 that extends to an outlet section 218 through an intermediate or duct portion 220. Inlet system 210 also includes an inlet chiller 230 having a condensate outlet 232 that passes condensate collecting at inlet section 216 from inlet system 210. In addition, a mist eliminator 234 is positioned downstream from inlet chiller 230 to limit moisture from passing through inlet system 210 into inlet portion 200 of compressor portion 184. Inlet chiller 230 lowers a temperature of air entering inlet section 216. Lowering a temperature of incoming air increases an overall mass flow rate of air through compressor portion 184. CCPP 180 also includes a steam turbine portion 240 fluidically connected to a heat recovery steam generator (HRSG) 245. HRSG 245 includes a condenser 246 and is fluidically coupled to an exhaust system (not shown) associated with turbine portion 186.

In accordance with an aspect of an exemplary embodiment, CCPP 180 includes an inlet chiller condensate recovery system 260 fluidically connected to inlet system 210. Inlet chiller condensate recovery system 260 includes a storage tank 263 having an inlet 266 fluidically connected to condensate outlet 232, a first outlet 268 and a second outlet 269. First outlet 268 of storage tank 263 is connected to a first pump 270. Specifically, first pump 270 includes an inlet portion 272 fluidically connected to first outlet 268 and an outlet portion 273. Outlet portion 273 is fluidically connected to a mixer 280. Mixer 280 includes a first inlet section 282 coupled to outlet portion 273 and a second inlet section 283 fluidically connected to a cooling water system 290. Mixer 280 also includes an outlet 300 fluidically connected to condenser 246 of HRSG 245. With this arrangement, inlet chiller condensate from inlet chiller 230 mixes with cooling water (water slightly above ambient) before being passed to condenser 246.

In addition to providing inlet chiller condensate to HRSG 245, inlet chiller condensate recovery system 260 may also be configured to deliver inlet chiller condensate to gas turbomachine system 182. More specifically, inlet chiller condensate recovery system 260 may include a second pump 310 including an inlet portion 312 fluidically connected to second outlet 269. Second pump 310 also includes an outlet portion 314 that delivers inlet chiller condensate to combustor 190. Inlet chiller condensate may pass through a de-ionizer 315 and an atomizer 320 that may also be connected to a liquid fuel source 324. Outlet portion 314 may also be connected to inlet portion 200 of compressor portion 184.

At this point it should be understood that the exemplary embodiments provide a system for recovering and re-using, or reclaiming, inlet chiller condensate from a gas turbomachine inlet system. The inlet chiller condensate may be employed in a variety of applications in both the gas turbomachine system and/or the steam turbomachine portion of the combined cycle power plant. For example, the inlet chiller condensate may be employed as a fluid injected into a combustor assembly to reduce NOx and other emissions. The re-use, or reclamation, of inlet chiller condensate is particularly advantageous in areas, such as the Middle East, in which water may be a scarce commodity. Reclaiming inlet chiller condensate provides various advantages, such as emission reduction, without incurring costs associated with the purchase, transport and storage of water from remote sources.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A gas turbomachine system comprising:
a compressor portion including an inlet portion;
a turbine portion fluidically connected to, and mechanically linked with, the compressor portion;
a combustor assembly including at least one combustor fluidically connected to the turbine portion;
an inlet system fluidically connected to the inlet portion of the compressor portion, the inlet system including an inlet chiller; and
an inlet chiller condensate recovery system fluidically connected to the inlet system, the inlet chiller condensate recovery system fluidically connected to the inlet chiller and one of the compressor portion and the combustor assembly.

2. The gas turbomachine according to claim 1, wherein the inlet chiller condensate recovery system includes a storage tank including an inlet fluidically connected to the inlet chiller and an outlet fluidically connected to the one of the compressor portion and the combustor assembly.

3. The gas turbomachine system according to claim 2, wherein the storage tank includes a de-ionizer.

4. The gas turbomachine system according to claim 2, further comprising:
a pump including an inlet portion fluidically connected to the storage tank and an outlet portion configured and disposed to guide inlet chiller condensate from the storage tank to the one of the compressor portion and the combustor assembly.

5. The gas turbomachine system according to claim 4, wherein the outlet portion of the pump is fluidically connected to the inlet portion of the compressor portion.

6. The gas turbomachine system according to claim 4, wherein the outlet portion of the pump is fluidically connected to the combustor assembly, the pump being configured and disposed to guide inlet chiller condensate from the storage tank into the at least one combustor.

7. The gas turbomachine system according to claim 6, further comprising:
an atomizer fluidically connected to the outlet portion of the pump, the atomizer being configured and disposed to introduce atomized inlet chiller condensate into the at least one combustor.

8. The gas turbomachine system according to claim 1, further comprising:
a mist eliminator arranged in the inlet system downstream of the inlet chiller.

9. A combined cycle power plant (CCPP) comprising:
a gas turbomachine system including a compressor portion having an inlet portion, a turbine portion fluidically connected to, and mechanically linked with, the compressor portion, and a combustor assembly including at least one combustor fluidically connected to the turbine portion;
an inlet system fluidically connected to the inlet portion of the compressor portion, the inlet system including an inlet chiller;
a steam turbine portion;
a heat recovery steam generator (HRSG) fluidically connected to the steam turbine portion; and
an inlet chiller condensate recovery system fluidically connected to the inlet system, the inlet chiller condensate recovery system being fluidically connected to the inlet chiller and the HRSG.

10. The combined cycle power plant according to claim 9, further comprising: a storage tank including an inlet fluidically connected to the inlet chiller and an outlet fluidically connected to the HRSG.

11. The combined cycle power plant according to claim 10, further comprising: a pump including an inlet portion fluidically connected to the outlet of the storage tank and an outlet portion fluidically connected to the HRSG.

12. The combined cycle power plant according to claim 11, wherein the HRSG includes a condenser, the outlet portion of the pump being fluidically connected to the condenser.

13. The combined cycle power plant according to claim 11, further comprising: a mixer including a first inlet section fluidically connected to the outlet of the pump, a second inlet section fluidically connected to a cooling water system and an outlet section fluidically connected to the HRSG.

14. A combined cycle power plant comprising:
a gas turbomachine system including a compressor portion having an inlet portion, a turbine portion fluidically connected to, and mechanically linked with, the compressor portion, and a combustor assembly including at least one combustor fluidically connected to the turbine portion;
an inlet system fluidically connected to the inlet portion of the compressor portion, the inlet system including an inlet chiller;
a steam turbine portion;
a heat recovery steam generator (HRSG) fluidically connected to the steam turbine portion; and
an inlet chiller condensate recovery system fluidically connected to the inlet system, the inlet chiller condensate recovery system being fluidically connected to the inlet chiller and one of the compressor portion, the combustor assembly, and the HRSG.

15. The combined cycle power plant according to claim 14, wherein the inlet chiller condensate recovery system includes a storage tank including an inlet fluidically connected to the inlet chiller and an outlet fluidically connected to the one of the compressor portion, the combustor assembly, and the HRSG.

16. The combined cycle power plant according to claim 15, further comprising: a first pump having an inlet portion fluidically connected to the outlet of the storage tank and an outlet portion configured and disposed to guide inlet chiller condensate from the storage tank to the one of the compressor portion and the combustor assembly.

17. The combined cycle power plant according to claim 16, wherein the outlet portion of the first pump is fluidically connected to the combustor assembly, the first pump being configured and disposed to guide inlet chiller condensate from the storage tank into the at least one combustor.

18. The combined cycle power plant according to claim 17, further comprising: an atomizer fluidically connected to the outlet portion of the first pump, the atomizer being configured and disposed to introduce atomized inlet chiller condensate into the at least one combustor.

19. The combined cycle power plant according to claim 16, further comprising: a second pump including an inlet portion fluidically connected to the outlet of the storage tank and an outlet portion fluidically connected to the HRSG.

20. The combined cycle power plant according to claim 19, further comprising: a mixer including a first inlet section fluidically connected to the outlet portion of the second pump, a second inlet section fluidically connected to a cooling system, and an outlet portion fluidically connected to the HRSG.
